(19) United States
(12) Patent Application Publication
(10) Pub. No.: US 2014/0008913 A1
(43) Pub. Date: Jan. 9, 2014

(54) Gasification Method, Gasification System and Integrated Coal Gasification Combined Cycle

(71) Applicant: Hitachi, Ltd., Tokyo (JP)

(72) Inventors: Tomoko AKIYAMA, Hitachinaka-shi (JP); Fumihiko KISO, Hitachinaka-shi (JP)

(21) Appl. No.: 13/935,028

(22) Filed: Jul. 3, 2013

(30) Foreign Application Priority Data
Jul. 6, 2012 (JP) 2012-152006

(51) Int. Cl. C10K 3/04; H02K 7/18; C01B 3/26

(52) U.S. Cl. CPC C10K 3/04; C01B 3/26; H02K 7/1823
USPC 290/52; 422/162; 252/373

(57) ABSTRACT

A method is provided for reducing an amount of steam to be introduced from the outside for a shift reaction in a coal gasification system. A coal gasification method for gasifying a fuel containing carbon, includes the steps of gasifying the fuel containing carbon by reacting the fuel with a gas containing oxygen; cooling a gas produced in the step of gasifying the fuel by spraying water into the produced gas; removing solid particles contained in the cooled produced gas; decomposing ammonia contained in the produced gas into N₂ and H₂ by bringing the produced gas, from which the solid particles have been removed, into contact with an ammonia decomposition catalyst; and converting a part of CO contained in the produced gas into CO₂ and H₂ by bringing the produced gas into contact with a shift catalyst.

### CLAIM OF PRIORITY

The present application claims priority from Japanese Patent Application JP 2012-152006 filed on Jul. 6, 2012, the content of which is hereby incorporated by reference into this application.

### FIELD OF THE INVENTION

The present invention relates to a gasification method of a fuel containing carbon.

### BACKGROUND OF THE INVENTION

In recent years, greenhouse effect based on carbon dioxide has been pointed out as a cause of the global warming phenomenon. Systems for capturing carbon dioxide with a high efficiency have been energetically developed centrally in thermal power plants, in which a large amount of fossil fuel is used. An integrated coal gasification combined cycle (abbreviated to “IGCC” hereinafter) gives a higher net thermal efficiency than conventional thermal powergeneration. Attention has beenpaid to the IGCC with CO₂ capture, in which a carbon dioxide capturing system is combined with the IGCC, as a system which can largely reduce the emission of carbon dioxide. In an IGCC with CO₂ capture, coal is gasified and then carbon monoxide contained in the produced gas is introduced to a shift catalyst to be reacted with steam. In this way, carbon monoxide is converted to hydrogen and carbon dioxide in accordance with a shift reaction shown in the formula (1),

CO+H₂O→CO₂+H₂ (1)

and then carbon dioxide is separated and captured from these products.

According to JP 8-151582, the temperature for the CO shift reaction is as high as 430° C. or higher. Thus, a high capture rate of CO₂ is not obtained unless a largely excessive amount of steam is added to CO, (see paragraphs 0004, 0028, 0029, for example.).

Conventional IGCCs with carbon dioxide capture have a problem that power generating efficiency is decreased because of a decrease in an amount of steam supplied to the steam turbine as much as used in capturing carbon dioxide. Moreover, in cases other than power generation systems, a problem is caused that an amount of steam to be used for utility steam is decreased.

An object of the present invention is to provide a method for gasifying a fuel including coal with a small loss by making the amount of steam used in the shift reaction less or to zero.

### SUMMARY OF THE INVENTION

The gasification method according to the present invention includes the steps of: gasifying the fuel containing carbon by reacting the fuel with a gas containing oxygen; cooling a gas produced in the step of gasifying the fuel by spraying water into the produced gas; removing solid particles contained in the cooled produced gas; decomposing ammonia contained in the produced gas into N₂ and H₂ by bringing the produced gas, from which the solid particles have been removed, into contact with an ammonia decomposition catalyst; and converting a part of CO contained in the produced gas into CO₂ and H₂ by bringing the produced gas into contact with a shift catalyst.

According to the gasification method of the present invention, the produced gas can be humidified at the same time of cooling the gasification furnace and the produced gas. It is therefore unnecessary to use steam to be used for power generation for the shift reaction. Thus, when the present system is a power generation system, the system can improve the net thermal efficiency than conventional systems. When the present system is a system other than power generation systems, the consumption of utility steam can be decreased in the whole system.

### BRIEF DESCRIPTION OF THE DRAWINGS

FIG. 1 is a block diagram illustrating a structure of a gasification system with CO₂ capture according to the embodiment 1;

FIG. 2 is a block diagram illustrating a structure of a gasification system with CO₂ capture according to the embodiment 2;

FIG. 3 is a block diagram illustrating a structure of a gasification system with CO₂ capture according to the embodiment 3;

FIG. 4 is a block diagram illustrating a structure of a gasification system with CO₂ capture according to the embodiment 4; and

FIG. 5 is an explanation drawing of a power generation plant and a steam utilization plant using a gasification system with CO₂ capture according to the embodiment 5.

### DESCRIPTION OF THE PREFERRED EMBODIMENTS

Hereinafter, embodiments of the present invention will be described with reference to the drawings. The invention is not limited to the embodiments.

The outline of the gasification system with CO₂ capture according to the invention is as follows. A fuel containing carbon is gasified by reacting the fuel with a gas containing oxygen. The produced gas is cooled and simultaneously humidified by spraying water into the produced gas. Solid particles are removed from the produced gas cooled and humidified, in which Ammonia is decomposed into N₂ and H₂ by bringing the produced gas into contact with an ammonia decomposition catalyst. The produced gas cooled and humidified is further brought into contact with a shift catalyst to convert a part of CO in the produced gas into CO₂ and H₂. A halogen compound contained in the produced gas is removed before or after the step of converting the part of CO into CO₂ and H₂. Thereafter, H₂S and CO₂ are independently or simultaneously separated from the produced gas.

According to the invention, the water which has been used to cool the produced gas turns into steam, which reaches the shift catalyst in the state of being contained in the produced gas. It is therefore unnecessary to use steam to be used for power generation for the shift reaction as in conventional techniques. Thus, the decrease in output of the steam turbine can be suppressed.

The produced gas covered in the invention is a gas that is generated by partially oxidizing a fuel containing carbon, such as coal, petroleum pitch or heavy oil, mainly including CO, H₂, CH₄, and CO₂.

Hereinafter, embodiments of the invention will be described. The invention is not limited to these embodiments.

### First Embodiment

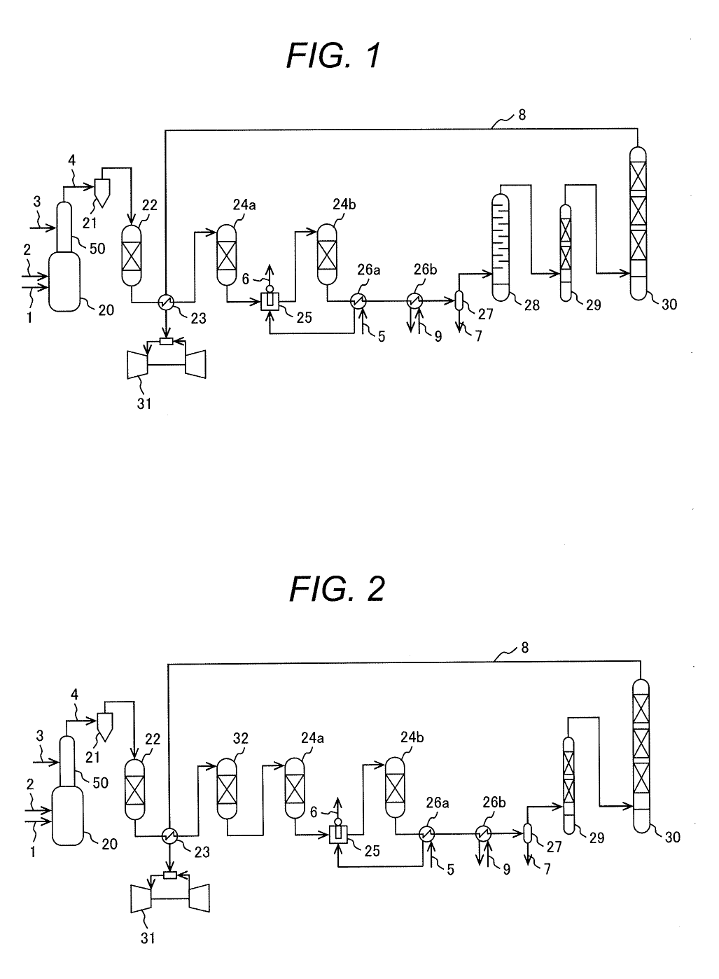

With reference to FIG. 1, an embodiment of the gasification system with CO₂ capture according to the invention will be described. In the embodiment 1, a basic structure of the gasification system with CO₂ capture according to the invention is applied to a gasification of coal. FIG. 1 is a block diagram illustrating a structure of the gasification system of the present embodiment with CO₂ capture.

As illustrated in FIG. 1, the gasification system of the present embodiment with CO₂ capture mainly includes a gasification furnace 20, a dust removal filter 21, an ammonia decomposition reactor 22, shift reactors 24a and 24b, a water washer 28, a desulfurization reactor 29, a CO₂ absorber 30, and a gas turbine 31.

In the gasification furnace 20, coal 1 and oxygen 2 are reacted with each other at high temperature to generate a produced gas 4. The produced gas 4 is cooled with water 3 sprayed by a water spraying unit 50 above the gasification furnace 20. Solid particles are removed from the cooled produced gas 4 by the dust removal filter 21. Thereafter, the produced gas 4 is introduced into the ammonia decomposition reactor 22. A Ru-carried SiO₂ catalyst, a Ni-carried SiO₂ catalyst, and an Fe catalyst are filled into the ammonia decomposition reactor 22. These catalysts promote a reaction represented by the formula (2) described below. The temperature of the ammonia decomposition reactor 22 is in a range of about 300 to 800° C. and is set to a temperature suitable for activating the filled catalysts.

2NH₃→N₂+H₂ (2)

In the step of cooling the gas produced in the step of gasifying the fuel by spraying water into the produced gas, the amount of the water to be sprayed is controlled to adjust the temperature of the cooled produced gas to be equal to or lower than the upper temperature limit of the filter to remove the solid particles contained in the produced gas and equal to or higher than the lowest operable temperature of the ammonia decomposition catalyst.

Next, the produced gas 4 is introduced into a heat exchanger 23, cooled to about 200° C. by a heat exchange with a purified gas 8 mainly including H₂, which is finally obtained in the present system, and then introduced into the shift reactor 24a. The shift reaction represented by the formula (1) is an exothermic reaction. The temperature of the produced gas 4 rises to about 400 to 500° C. at the exit of the shift reactor 24a. The produced gas 4 is introduced into a steam generator 25 to be cooled to about 200° C. The produced gas 4 is further introduced into the shift reactor 24b. The temperature of the produced gas 4 also rises at the exit of the shift reactor 24b.

The shift reactors 24a and 24b are filled with, for example, a molybdenum based catalyst capable of promoting the shift reaction in the presence of H₂S. In the shift reactors 24a and 24b, a reaction represented by the following formula (3) also advances so that COS is converted into H₂S:

COS+H₂O→H₂S+CO₂. (3)

The produced gas 4 is cooled to about 40° C. by passing through coolers 26a and 26b. Condensed water 7 is separated from the produced gas 4 in a gas-liquid separator 27, and then the produced gas 4 is introduced into the water washer 28. In the water washer 28, which is a halogen removal reactor, halogen compound and a part of H₂S mainly contained in the produced gas 4 are removed. Furthermore, most of the rest of H₂S is removed from the produced gas 4 in the desulfurization reactor 29. Finally, CO₂ is removed from the produced gas 4 in the CO₂ absorber 30 to yield the purified gas 8.

The purified gas 8 is introduced into the heat exchanger 23, heated there by the produced gas 4 that has passed through the ammonia decomposition reactor 22, and then introduced into the gas turbine 31.

A coolant for the cooler 26b may be a liquid absorbent 9 that has absorbed CO₂ and been taken out from the CO₂ absorber 30. In the cooler 26b, steam which has not subjected to the shift reaction condenses to generate latent heat. The liquid absorbent 9 is heated by sensible heat of the produced gas 4 and the condensation latent heat of the steam, so that the elimination of CO₂ absorbed in the absorbent is promoted. Thus, the liquid absorbent 9 is recovered.

In the meantime, when a produced gas is cooled to about 270° C., a problem is conventionally caused that chlorine and ammonia contained in the produced gas react with each other to produce solid ammonium chloride, which precipitates on the catalyst or the filter. Ammonia is high in solubility in water. Thus, the concentration of ammonia in the produced gas is lowered by cooling the produced gas to about 40° C. and separating the condensed water. Accordingly, in conventional systems, even when the produced gas is humidified in a gasification furnace, water is hardly contained in the produced gas that has passed through an ammonia removing step. As a result, it is indispensable that all the necessary amount of steam to be used for the shift reaction is added in the CO shift step. However, according to the present embodiment, only ammonia can be removed from the produced gas containing water. Thus, the amount of steam to be newly added for the shift reaction may be zero or a slight amount. Additionally, it is unnecessary to consider the precipitation of ammonia chloride because ammonia is substantially completely decomposed by using the catalysts. For this reason, the shift reactors 24a and 24b can be operated at a low temperature of 270° C. or lower. This matter results in an advantageous effect that the amount of steam theoretically necessary for the shift reaction is decreased. Consequently, a predetermined CO shift performance can be obtained only by water that has been sprayed to cool the produced gas.

In conventional systems, steam to be used for power generation, which is also used for the shift reaction, is generated from very high-purity water in order to protect the steam turbine. However, even when steam which has not been subjected to the shift reaction is condensed, water-soluble substances such as H₂S and HCl are dissolved therein. Thus, it is indispensable to treat the condensed water as waste water. For this reason, the extracted steam for the shift reaction results in problems of not only a decrease in the output of the steam turbine but also an increase in operating costs based on an increase in the amount of water to be supplemented to the boiler. The present embodiment can yield a secondary advantageous effect of decreasing operating costs since water to be sprayed into the produced gas may be water lower in purity than the water to be supplemented to the boiler.

As described above, the gasification method of the present embodiment is a coal gasification method for gasifying a fuel containing carbon, including the steps of: gasifying the fuel containing carbon by reacting the fuel with a gas containing oxygen; cooling a gas produced in the step of gasifying the fuel by spraying water into the produced gas; removing solid particles contained in the cooled produced gas; decomposing ammonia contained in the produced gas into N₂ and H₂ by bringing the produced gas, from which the solid particles have been removed, into contact with an ammonia decomposition catalyst; and converting a part of CO contained in the produced gas into CO₂ and H₂ by bringing the produced gas into contact with a shift catalyst. This method makes it possible to cool the gasification furnace and the generated gas, and simultaneously to humidify the produced gas. Thus, it is unnecessary to use steam to be used for power generation for the shift reaction. When the method is used in a power generation system, the net thermal efficiency can be improved than before. When the method is used in a system other than power generation systems, the consumption of utility steam can be reduced.

As described above, the coal gasification system of the present embodiment is a coal gasification system, including a gasification furnace (20) configured to gasify a fuel containing carbon by reacting the fuel with a gas containing oxygen; a water spraying unit (50) configured to cool a gas produced by the gasification furnace by spraying water into the produced gas ; a dust removal filter (21) configured to remove solid particles contained in the cooled produced gas; an ammonia decomposition reactor (22) configured to decompose ammonia contained in the produced gas into N₂ and H₂ by bringing the produced gas, from which the solid particles have been removed, into contact with an ammonia decomposition catalyst; and a shift reactor (24) configured to convert a part of CO contained in the produced gas into CO₂ and H₂ by bringing the produced gas, in which ammonia has been decomposed, into contact with a shift catalyst. This system makes it possible to cool the gasification furnace and the generated gas, and simultaneously to humidify the produced gas. Thus, it is unnecessary to use steam to be used for power generation for the shift reaction. When the method is used in a power generation system, the net thermal efficiency can be improved than before. When the method is used in a system other than power generation systems, the consumption of utility steam can be reduced.

When the produced gas 4 introduced into the steam generator 25 is cooled to about 200° C., hot water is allowed to flow in as the coolant for heat exchange with the gas, generating steam 6. The amount of the steam supplied from the outside can be decreased by setting a heat exchanger at the downstream of the shift reactor, recovering heat of the gas at the exit of the shift reactor, and then using the recovered heat as a heat source for generating steam for the shift reaction. This matter can be applied to other embodiments to be described below.

When the produced gas 4 that has passed through the coolers 26a and 26b is cooled to about 40° C., the coolant subjected to heat exchange with the gas is hot water 5. The amount of the steam supplied from the outside can be decreased by recovering heat of the gas at the exit of the shift reactor and using the recovered heat as a heat source for generating steam for the shift reaction, such as using the hot water 5 as the hot water to be allowed to flow in the steam generator 25. This matter can be applied to other embodiments to be described below.

The above-mentioned configurations of the steam generator 25, the coolers 26a and 26b, and others are just examples. These configurations may take different configurations. This matter can be applied to other embodiments to be described below.

In the present embodiment, as the gasification system with CO₂ capture, the step up to separating and capturing CO₂ in the CO₂ absorber 30 is described. It is possible to use a gas obtained by converting a part of CO into CO₂ and H₂ in the shift reactors 24 or to separate and capture CO₂ gas by using any one or any combination of the coolers 26, the gas-liquid separator 27, the water washer 28 and the desulfurization reactor 29 in accordance with a usage of the gasified gas. This matter can be applied to other embodiments to be described below.

### Second Embodiment

With reference to FIG. 2, the embodiment 2 according to the present invention will be described. The embodiment 2 is an embodiment in which a gasification system with CO₂ capture according to the invention is applied to a coal gasification process in the same way as in the embodiment 1. However, the embodiment 2 is different from the embodiment 1 in that halogen compound is removed between the ammonia decomposition step and the shift reaction step.

FIG. 2 is a block diagram illustrating a structure of a gasification system with CO₂ capture of the present embodiment. In FIG. 2, the same reference characters as in FIG. 1 represent elements identical or common to the elements in FIG. 1. Main units configuring the gasification system with CO₂ capture of the present embodiment are identical to those in the embodiment 1, except that the step of removing halogen is performed in a halogen removal reactor 32 which is a dry halogen removal reactor, and this reactor 32 is located before the shift reactor 24a.

In the present embodiment, most of the method for operating the gasification system with CO₂ capture is the same as in the embodiment 1. Only differences from the embodiment 1 will be described hereinafter.

Ammonia contained in the produced gas 4 is decomposed into N₂ and H₂ in the ammonia decomposition reactor 22, and subsequently the produced gas 4 is cooled to a predetermined temperature in the heat exchanger 23. Thereafter, the produced gas 4 is introduced into the halogen removal reactor 32 filled with a halogen absorbent so that compounds containing halogen such as Cl or F are removed in the reactor 32. When the temperature for operating the halogen removal reactor 32 is higher than 200° C., the produced gas 4 is cooled to 200° C. and subsequently introduced into the shift reactor 24a.

In the present embodiment, the halogen compounds are removed before the shift reactors 24a and 24b as described above, leading to advantageous effects of making the lifespan of the shift catalyst long and thereby reducing operating costs. Furthermore, because halogen compounds do not flow into the shift reactors and the units subsequent thereto, a risk of corroding the materials of these units is reduced. As a result, another advantageous effect can be obtained that inexpensive materials can be selected for the units to decrease the costs for the system.

In the present embodiment, the dry halogen removal reactor 32 is used for a halogen removal reactor. However, a wet reactor such as a water washer may be used for a halogen removal reactor. In this case, the produced gas 4 can hold steam necessary for the shift reaction at the amount of saturated vapor by operating the system so that the gas temperature at the exit of the halogen removal reactor is set to 190° C. or higher.

It is also possible to install a unit for adding steam to the produced gas 4 at any position from the exit of the halogen removal reactor to the shift reactors in order to bring the produced gas 4 into contact with the shift catalyst to convert a part of CO contained in the produced gas into CO₂ and H₂. and then introduce the steam (the steam 6, for example) from the outside into the shift reactors 24 so that the gas temperature at the exit of the halogen removal reactor is set to 120° C. or higher.

### Third Embodiment

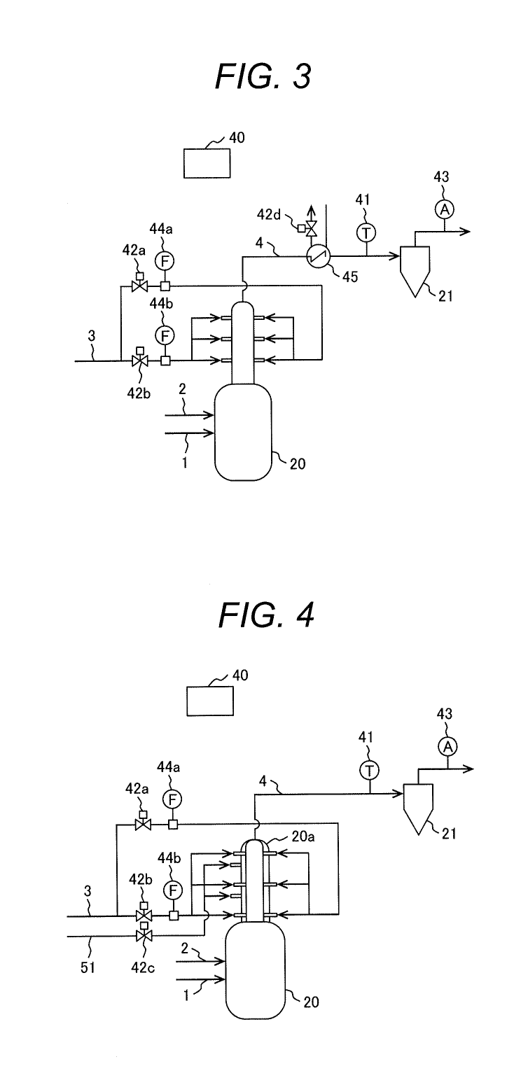

With reference to FIG. 3, the embodiment 3 of the coal gasification system with CO₂ capture according to the invention will be described. In the embodiment 3, a method is described for controlling an operation of spraying water into the produced gas in a coal gasification system with CO₂ capture, having an equivalent configuration to the systems in the embodiments 1 and 2.

FIG. 3 is a block diagram illustrating the gasification furnace 20, the dust removal filter 21, and units necessary for controlling the spray amount of water in the coal gasification system with CO₂ capture of the present embodiment. In FIG. 3, the same reference characters as in FIG. 1 represent elements identical or common to the elements in FIG. 1.

A cooler 45 and a thermometer 41 are located between the gasification furnace 20 and the dust removal filter 21 in the passage of the produced gas 4. Furthermore, a gas analyzer 43 is located at the exit of the dust removal filter 21. Flow-rate adjusting valves 42a and 42b, and flow-rate meters 44a and 44b are located in the passages of water to be sprayed into the gasification furnace 2. A controller 40 is installed for adjusting the opening degrees of the flow-rate adjusting valves 42a and 42b and a flow-rate adjusting valve 42d (described below) based on values measured by the thermometer 41 and the gas analyzer 43.

First, with the gas analyzer 43, the concentrations of CO and water are measured in the produced gas 4, from which dusts have been removed. The measured values are inputted into the controller 40. The controller 40 memories a computation expression for computing the spray amount of water necessary for the shift reaction under a condition that a water concentration is considered relative to the inputted CO concentration. This computation expression is beforehand set according to tests in advance or theoretical expressions. The controller 40 receives outputs from the flow-rate meters 44a and 44b, and outputs the opening degrees of the flow-rate adjusting valves 42a and 42b to make the received values consistent with the flow rates of water obtained with the computation expression. In this way, the spray amount of water is automatically adjusted. Simultaneously with this adjustment, the controller 40 also receives the temperature of the produced gas 4 at the exit of the cooler 45, the temperature being measured with the thermometer 41. In the controller 40, a target temperature is beforehand set. The flow rate of the coolant in the cooler 45 is adjusted by the flow-rate adjusting valve 42d to make the temperature of the produced gas 4 close to the set target temperature.

In the present embodiment, many nozzles for spraying water into the gasification furnace 20 are arranged in a multi-level or multistage manner. Water is distributed into the respective nozzles at appropriate proportions to be sprayed. In this way, the sprayed water is reliably gasified so that the produced gas is obtained containing a necessary amount of steam for the shift reaction. Moreover, a delay in water evaporation prevents waterdrops from dropping down to the lower part of the gasification furnace, and also prevents aggregation of coal associated with this dropping-down of waterdrops.

As described above, the amount of the steam for the shift reaction can be automatically controlled, and simultaneously the temperature of the produced gas flowing into the dust removal filter can be automatically controlled.

It is possible to independently perform the flow-rate control for setting the temperature of the produced gas to the target temperature and the spray of water by the multi-level or multistage nozzles for ensuring the water evaporation.

### Forth Embodiment

With reference to FIG. 4, the embodiment 4 of the coal gasification system with CO₂ capture according to the invention will be described. In the embodiment 4, another method is described for controlling an operation of spraying water into the produced gas in a coal gasification system with CO₂ capture, having an equivalent configuration to the systems in the embodiments 1 and 2.

FIG. 4 is a block diagram illustrating the gasification furnace 20, the dust removal filter 21, and units necessary for controlling the spray amount of water in the coal gasification system with CO₂ capture of the present embodiment. In FIG. 4, the same reference characters as in FIG. 3 represent elements identical or common to the elements in FIG. 3.

The gasification furnace 20 of the present embodiment has a heat recovering section 20a on the top thereof. The heat recovering section 20a has a water-cooled tube in it.

When purified gas is used as a raw material for chemical synthesis, it is necessary to set the ratio of CO and H₂ in the produced gas after the shift reaction to a predetermined ratio. In the same way as in the embodiment 3, the controller 40 receives the concentrations of CO, H₂ and water that are measured by the gas analyzer 43 at the exit of the dust removal filter 21. The controller 40 memories a computation expression used for computing the spray amount of water necessary for the shift reaction in order to gain a predetermined ratio between CO and H₂. This computation expression is beforehand set according to tests in advance or theoretical expressions. The controller 40 receives outputs from the flow-rate meters 44a and 44b, and outputs the opening degrees of the flow-rate adjusting valves 42a and 42b to make the received values consistent with the flow rates of water obtained with the computation expression. In this way, the spray amount of water is automatically adjusted. Simultaneously with this adjustment, the controller 40 also receives the temperature of the produced gas 4, which is measured with the thermometer 41. In the controller 40, a target temperature is beforehand set. The flow rate of the cooling water 51 to be introduced into the heat recovering section 20a is adjusted by a flow-rate adjusting valve 42c to make the temperature of the produced gas 4 close to the set target temperature.

According to the present embodiment, even when the spray amount of water is small and the temperature of the upper part of the gasification furnace is high, because of the heat recovering section 20a, inner walls of the upper part of the gasification furnace are cooled, preventing a damage of the walls of the furnace.

### Fifth Embodiment

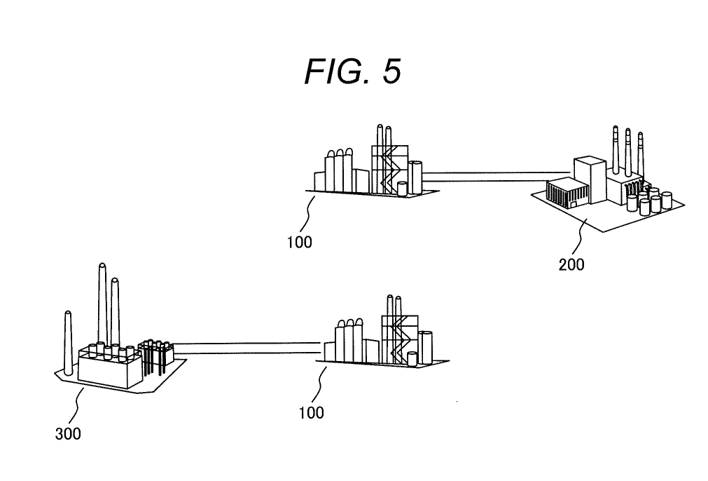

FIG. 5 is an explanation drawing of a power generation plant and a steam utilization plant using a gasification system with CO₂ capture. FIG. 5 illustrates a gasification system 100 with CO₂ capture to which any one system of the embodiments 1 to 4 is applied and a power generation plant 200 in which the produced gas from the gasification system 100 with CO₂ capture is used to generate electric power. Examples of the power generation plant 200 include a coal thermal power generation plant and a combined cycle power generation plant, in which a gas turbine is driven and steam obtained from the exhaust gas from the gas turbine is used to drive a steam turbine to generate electric power. Ammonia is removed from the produced gas containing water with water remained in the gas by a method of an integrated coal gasification combined cycle with CO₂ capture, using the produced gas obtained by the coal gasification method with CO₂ capture that has been described in, for example, the embodiment 1 to drive the gas turbine, and then using steam obtained from the exhaust gas from the gas turbine to drive a steam turbine, thus generating electric power. In this way, the amount of steam to be newly added for the shift reaction may be zero or a slight amount so that the amount of the steam necessary for the shift reaction is small. Thus, it is unnecessary to use the steam to be used for power generation for the shift reaction, or the usage of the steam for the shift reaction can be reduced. As a result, the net thermal efficiency is improved in the present embodiment than in conventional techniques.

Moreover, FIG. 5 illustrates a gasification system 100 with CO₂ capture to which any one system of the embodiments 1 to 4 is applied and a steam utilization plant 300 in which the produced gas is used or in which steam is produced and used. An example of the steam utilization plant 300 is a chemical-product manufacturing plant. The coal gasification plant of any one of the embodiments 1 to 4 can be applied to a coal gasification plant to produce CO and H₂ for manufacturing chemical products. Another example of the steam utilization plant 300 is a plant for hydrogen-reduction iron manufacture. The coal gasification plant of any one of the embodiments 1 to 4 can also be applied to a coal gasification plant to produce H₂ for hydrogen-reduction iron manufacture. Also in this embodiment, by removing ammonia from the produced gas containing water with water remained in the gas, the amount of steam to be newly added for the shift reaction may be zero or a slight amount so that the amount of the steam necessary for the shift reaction is small. Thus, it is unnecessary to use the steam to be used in the plant for the shift reaction, or the usage of the steam for the shift reaction can be reduced.

Alternatively, regardless of the steam inside the plant, it is unnecessary to separately produce the steam necessary for the shift reaction, or the production of the steam can be reduced. As a result, the steam utilization efficiency is improved in the present embodiment than in conventional techniques.

What is claimed is:

1. A coal gasification method for gasifying a fuel containing carbon, comprising the steps of:
gasifying the fuel containing carbon by reacting the fuel with a gas containing oxygen;
cooling a gas produced in the step of gasifying the fuel by spraying water into the produced gas;
removing solid particles contained in the cooled produced gas;
decomposing ammonia contained in the produced gas into N₂ and H₂ by bringing the produced gas, from which the solid particles have been removed, into contact with an ammonia decomposition catalyst; and
converting a part of CO contained in the produced gas into CO₂ and H₂ by bringing the produced gas into contact with a shift catalyst.

2. The coal gasification method according to claim 1,
wherein, in the step of cooling a gas produced in the step of gasifying the fuel by spraying water into the produced gas, an amount of the water to be sprayed is controlled to adjust a temperature of the cooled produced gas to be equal to or lower than an upper temperature limit of a filter to remove the solid particles contained in the produced gas and equal to or higher than a lowest operable temperature of the ammonia decomposition catalyst.

3. The coal gasification method according to claim 1,
wherein, in the step of cooling a gas produced in the step of gasifying the fuel by spraying water into the produced gas, the water is sprayed in a multistage manner.

4. The coal gasification method according to claim 1, further comprising the step of:
removing a halogen compound contained in the produced gas after the step of converting a part of CO contained in the produced gas into CO₂ and H₂ by bringing the produced gas into contact with a shift catalyst.

5. The coal gasification method according to claim 1, further comprising the step of:
removing a halogen compound contained in the produced gas before the step of converting a part of CO contained in the produced gas into CO₂ and H₂ by bringing the produced gas into contact with a shift catalyst.

6. The coal gasification method according to claim 5,
wherein the step of removing a halogen compound is performed so that a temperature of the produced gas is equal to or higher than 190° C. after the step of removing a halogen compound.

7. The coal gasification method according to claim 5,
wherein the step of removing a halogen compound is performed so that a temperature of the produced gas is equal to or higher than 120° C. after the step of removing a halogen compound, and subsequently steam is added to the produced gas to convert the part of CO contained in the produced gas into CO₂ and H₂ by bringing the produced gas into contact with the shift catalyst.

8. The coal gasification method according to claim 1, further comprising the step of:
separating and capturing CO₂ after the step of converting a part of CO contained in the produced gas into CO₂ and H₂ by bringing the produced gas into contact with a shift catalyst.

9. A method for generating electricity in an integrated coal gasification combined cycle, comprising the steps of:
driving a gas turbine by using the produced gas obtained in the coal gasification method according to claim 1; and
generating electricity by driving a steam turbine with steam obtained from exhaust gas from the gas turbine.

10. A coal gasification system, comprising:
a gasification furnace configured to gasify a fuel containing carbon by reacting the fuel with a gas containing oxygen;
a water spraying unit configured to cool a gas produced by the gasification furnace by spraying water into the produced gas;
a dust removal filter configured to remove solid particles contained in the cooled produced gas;
an ammonia decomposition reactor configured to decompose ammonia contained in the produced gas into N₂ and H₂ by bringing the produced gas, from which the solid particles have been removed, into contact with an ammonia decomposition catalyst; and
a shift reactor configured to convert apart of CO contained in the produced gas into CO₂ and H₂ by bringing the produced gas, in which ammonia has been decomposed, into contact with a shift catalyst.

11. The coal gasification system according to claim 10, further comprising:
a controller configured to control an amount of the water to be sprayed in the water spraying unit to adjust a temperature of the cooled produced gas to be equal to or lower than an upper temperature limit of the dust removal filter and equal to or higher than a lowest operable temperature of the ammonia decomposition catalyst.

12. The coal gasification system according to claim 10,
wherein the water spraying unit is configured to spray the water into the produced gas in a multistage manner.

13. The coal gasification system according to claim 10, further comprising:
a halogen removal reactor configured to remove a halogen compound contained in the produced gas after the shift reactor converts the part of CO contained in the produced gas into CO₂ and H₂ by bringing the produced gas into contact with the shift catalyst.

14. The coal gasification system according to claim 10, further comprising:
a halogen removal reactor configured to remove a halogen compound contained in the produced gas before the shift reactor converts the part of CO contained in the produced gas into CO₂ and H₂ by bringing the produced gas into contact with the shift catalyst.

15. The coal gasification system according to claim 14,
wherein the halogen removal reactor is configured to remove the halogen compound so that a temperature of the produced gas is equal to or higher than 190° C. after the halogen removal reactor removes the halogen compound.

16. The coal gasification system according to claim 14, further comprising:
a unit configured to add steam to the produced gas at any position from an exit of the halogen removal reactor to the shift reactor to convert the part of CO contained in the produced gas into CO₂ and H₂ by bringing the produced gas into contact with the shift catalyst;
wherein the halogen removal reactor is configured to remove the halogen compound so that a temperature of the produced gas is equal to or higher than 120° C. after the halogen removal reactor removes the halogen compound.

17. The coal gasification system according to claim 10, configured to separate and capture CO₂ after the shift reactor converts the part of CO contained in the produced gas into CO₂ and H₂ by bringing the produced gas into contact with the shift catalyst.

18. An integrated coal gasification combined cycle system comprising:
a gas turbine configured to be driven by the produced gas obtained in the coal gasification system according to claim 10; and
a steam turbine configured to be driven with steam obtained from exhaust gas from the gas turbine to generate electricity.
